(19) United States
(12) Patent Application Publication
(10) Pub. No.: US 2014/0245159 A1
(43) Pub. Date: Aug. 28, 2014

(54) TRANSPORT SCRIPT GENERATION BASED ON A USER INTERFACE SCRIPT

(71) Applicant: HEWLETT-PACKARD DEVELOPMENT COMPANY, L.P., Houston, TX (US)

(72) Inventors: Ithai Levi, Yehud (IL); Moshe Eran Kraus, Yehud (IL); Meidan Zemer, Yehud (IL)

(21) Appl. No.: 13/781,221

(22) Filed: Feb. 28, 2013

(51) Int. Cl. H04L 12/24

(52) U.S. Cl. CPC H04L 41/22
USPC 715/736

(57) ABSTRACT

Transport script generation based on a user interface script is disclosed herein. An example apparatus comprises a processor and a memory comprising machine-readable instructions. When executed by the processor, the machine-readable instructions cause the processor to monitor network requests in response to execution of a user interface script. The processor is to modify a transport script based on the network requests by determining whether a first one of the network requests corresponds to a user interface script command of the user interface script, and, when the first network request corresponds to the user interface script command, inserting the user interface script command as a comment to the transport script.

### BACKGROUND

Servers provide information to requesting clients via networks such as the Internet. Such servers are frequently upgraded to provide additional features, usability, etc. to users. Users expect that a server will perform at or above levels of previous performance after such upgrades. To identify whether a server has degraded in performance after an upgrade, performance tests are executed to measure a performance level of the server. Such performance tests simulate a load on the server to determine a performance value and/or to ensure that the server does not fail under a load. The load may represent a number of users performing various tasks, operations on the server, etc.

### BRIEF DESCRIPTION OF THE DRAWINGS

FIG. 1 illustrates an example load tester constructed in accordance with the teachings of this disclosure to generate a transport script.

FIG. 2 illustrates an example system constructed in accordance with the teachings of this disclosure and including the load tester of FIG. 1.

FIG. 3 illustrates an alternate implementation of the example system of FIG. 2.

FIG. 4 illustrates an example user interface script that may be used to regenerate a transport script.

FIG. 5 illustrates an example transport script that may be used to perform load testing on the example application server of FIG. 1.

FIG. 6 is a flowchart representative of example machine-readable instructions that may be executed to implement the example load tester of FIG. 1 to generate a UI script and a transport script.

FIG. 7 is a flowchart representative of example machine-readable instructions that may be executed to implement the example load tester of FIG. 1 to generate the transport script.

FIG. 8 is a flowchart representative of example machine-readable instructions that may be executed to implement the example load tester of FIG. 1 to integrate UI level information into the transport script.

FIG. 9 is a flowchart representative of example machine-readable instructions that may be executed to implement the example load tester of FIG. 1 to generate the transport script.

### DETAILED DESCRIPTION

A load test is a test that is directed to a server to determine if the server meets or exceeds a given performance criteria. The server may be, for example, a server that responds to requests for, for example, a webpage (e.g., a web server). Servers typically support large numbers (e.g., ten thousand or more) of users simultaneously. Accordingly, when a change is made to the server, testing the server after the change with requests from a single user is usually not adequate. The load test simulates multiple users to more adequately simulate real world conditions. Thus, server issues can be identified during the development process, rather than having such issues discovered once the server is live (e.g., under an actual load).

Load testing is an important aspect of server and/or application development. Load testing systems execute scripts and/or test plans to test the performance of servers and/or applications throughout the development process. For example, as a new feature is developed, a performance test may be automatically performed to ensure that there has been no degradation in performance. Two types of performance testing are: (1) user interface (UI) tests and (2) transport and/or network level tests.

A user interface (UI test is a test that simulates user interaction with an application communicating with the server. Simulated user interaction may include, for example, mouse clicks, mouse movements, keystrokes, delays, etc. A UI test is performed by execution of a UI script. The UI script includes a series of actions that simulate interaction with a user interface provided by the server (e.g., interaction with a user interface of a website). When an underlying structure of a web application is changed, the user interface does not necessarily change. For example, a change to a search may not impact how a search interface is displayed. Tests performed by UI scripts are resilient to such changes because the tests are not dependent on the underlying functionality of the server.

UI scripts, while resilient to underlying implementation changes to a server, have poor performance. For example, to implement a UI script, the testing system must simulate user interaction with the interface. Such interaction may include mouse movements, mouse clicks, keystrokes, delays, etc. Simulating such interaction is resource intensive and is difficult to extrapolate to more than a few simulated sessions (e.g., simulated users) at a time.

Transport scripts simulate network interactions with the server. Transport and/or network tests are performed by execution of a transport script. Transport scripts, unlike UI scripts, are easily extrapolated to simulate many users (e.g., ten thousand or more users). For example, in normal operation when a user is interacting with a server, the user may input a search parameter and execute a search query. The search query may trigger the transmission of a request (e.g., a HyperText Transfer Protocol (HTTP) request) to the server. To simulate many users, the testing system may transmit a selected number of requests to the server. A response to each request may be verified to ensure that the server is functioning properly under the test load.

Simulating a large number of requests by a transport script is less resource intensive than simulating a large number of user interactions with a UI script. However, transport scripts are not resilient to changes in the underlying functionality of a server. For example, if a name of a parameter included in a request is modified during development, executing a transport script may give improper results. Because application testing is part of the development process, servers are frequently tested during development to ensure that there is no regression (e.g., broken features, degradation of usability, lower performance, etc.). However, maintaining transport scripts so that they correspond to changes in the server during the development cycle of the server is time consuming and is sometimes overlooked by application developers. Because maintaining transport scripts is difficult, developers may choose to load test the server infrequently during the development cycle (e.g., as a major build of the server is finished, as a final version of a web application is completed, etc.). Infrequent load testing reduces the ability of a developer to identify changes that cause reduced performance. However, transport scripts are susceptible to problems such as, for example, misconfiguration of the transport script due to an update to the server, a failure of the server to respond to a network request. When a problem is identified during testing, an engineer investigates the transport script to identify whether the problem was caused by a misconfiguration of the transport script.

Example methods, apparatus, and articles of manufacture disclosed herein enable generation of transport scripts that are easy to investigate and maintain. In examples disclosed herein, transport scripts are generated based on the UI scripts by executing the UI script while recording network requests to create the transport script. The transport script is then modified to include information from the UI script. For example, transactions (e.g., groups of activities within the UI script) are identified in the transport script, parameters are identified within the transport script, comments describing user activity of the UI script are added, origins of the requests of the transport script (e.g., whether the request originated from a user input, whether the request originated as a result of an action of the server, etc.) are added to the transport script, and/or screenshots of the user activity are added to the transport script. In examples disclosed herein, the transport script is updated based on the UI script. Accordingly, accurate load tests can be performed more frequently, thereby enabling developers to identify performance problems in early stages of development. Accordingly, transport script generation does not require user intervention, and the transport script can be continually maintained throughout the development process. Further, because the transport script is maintained, the time that developers must spend creating test scripts is reduced.

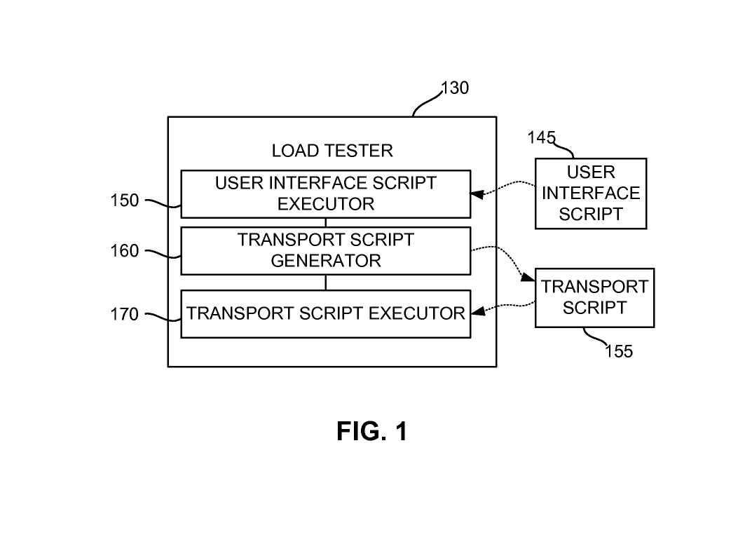

FIG. 1 illustrates an example load tester 130 constructed in accordance with the teachings of this disclosure to generate a transport script. The example load tester 130 of the illustrated example of FIG. 1 includes a user interface script executor 150, a transport script generator 160, and a transport script executor 170. In operation, the example user interface script executor 150 executes an example user interface script 145. At the same time, the transport script generator 160 generates an example transport script 155. In the illustrated example, the transport script generator 160 generates the transport script 155 by monitoring network communications of the load tester 130 directed towards a server. To perform a load test, the transport script executor 170 executes the transport script 155 generated by the transport script generator 160.

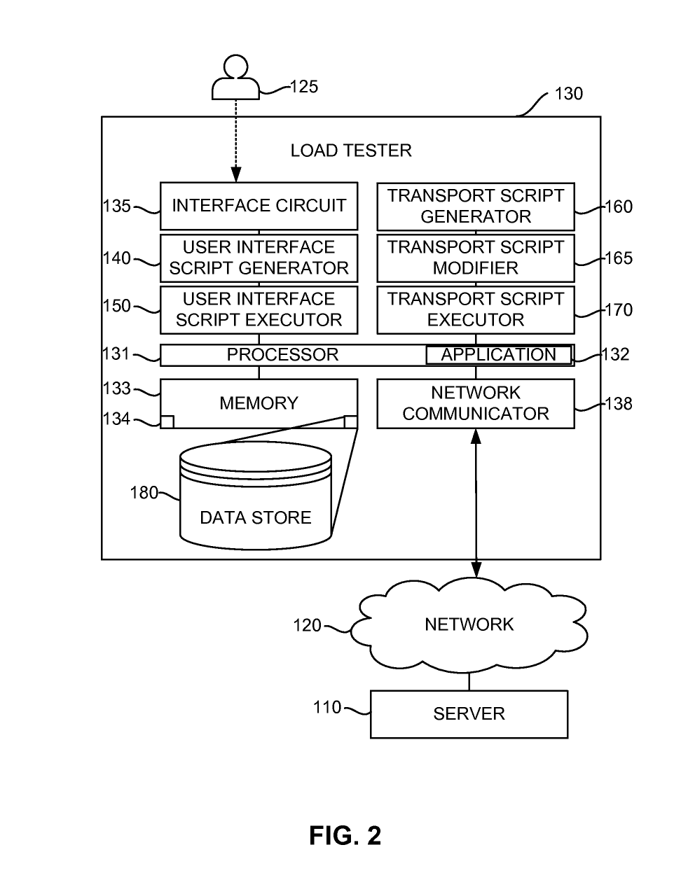

FIG. 2 illustrates an example system 200 for load testing, which includes the load tester 130 of FIG. 1, a network 120 and a server 110. The example server 110 of FIG. 2 is implemented by a processor executing instructions, but could be additionally or alternatively implemented by an application specific integrated circuit(s) (ASIC(s)), programmable logic device(s) (PLD(s)) and/or field programmable logic device(s) (FPLD(s)), and/or other analog and/or digital circuitry. In the illustrated example, the server 110 is a web server that hosts Internet content (e.g., webpages, images, video, etc.). The server 110 of the illustrated example responds to requests for Internet content that are received via hypertext transfer protocol (HTTP). However, any other past, present, and/or future protocols and/or types of requests may additionally and or alternatively be used. Further, any other type of server 110 may additionally or alternatively be used. For example, the server 110 may be a database server that responds to data queries such as, for example, structured query language (SQL) queries. In examples disclosed herein, the server 110 is a physical hardware server. However, in some examples, the server 110 is implemented as a software program (e.g., a server daemon).

The example network 120 of the illustrated example of FIG. 2 is a local network. However, any other network could additionally or alternatively be used. For example, some or all of the network 120 may be a company's intranet network, a personal (e.g., home) network, the Internet, etc. Although the network 120 of the illustrated example operates based on the HTTP and IP protocols, the network 120 may additionally or alternatively use any other protocol to enable communication between devices on the network. In the illustrated example, the network 120 is a physical network. However, in some examples, the network may be a virtual network such as, for example, a virtual private network (VPN), etc.

The example load tester 130 of the illustrated example includes a processor 131, a memory 133, an interface circuit 135, a network communicator 138, a user interface script generator 140, the user interface script executor 150, the transport script generator 160, a transport script modifier 165, and the transport script executor 170.

The example processor 131 of the illustrated example of FIG. 2 is hardware. The processor 131 can be implemented by one or more integrated circuits, logic circuits, microprocessors, or controllers from any desired processor family or manufacturer. The processor 131 includes a local memory (e.g., a cache) and is in communication with the example memory 133 via a bus.

In the illustrated example, the example processor 131 executes an application 132 that communicates with the server 110. The example application 132 is a browser (e.g., Microsoft Internet Explorer®, Mozilla Firefox®, Apple Safari®, Google Chrome™, etc.). However, any other application that communicates with the server 110 may additionally or alternatively be used. For example, the application 132 may be a database application.

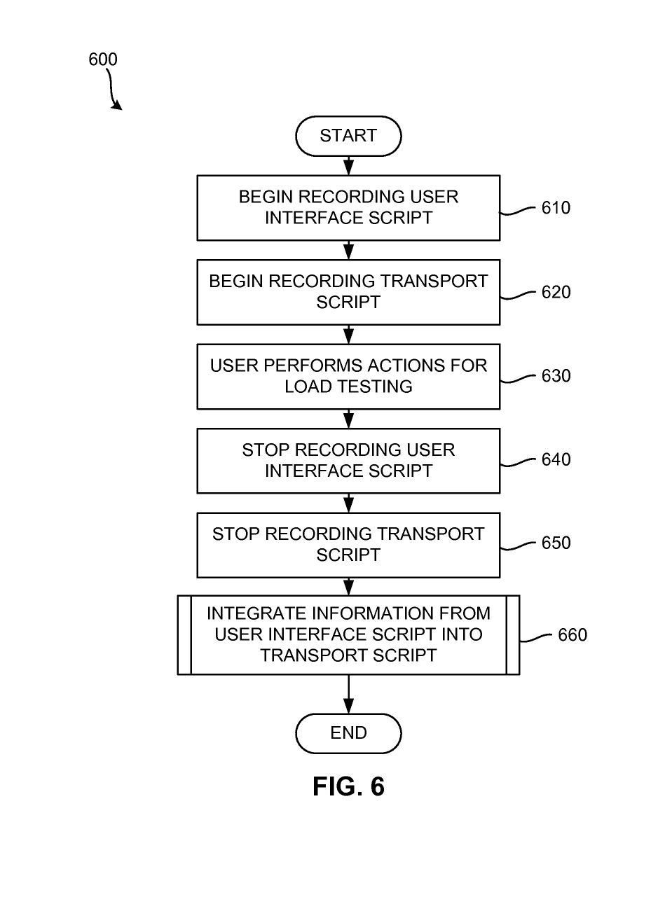

The example memory 133 of the illustrated example of FIG. 2 is implemented by Synchronous Dynamic Random Access Memory (SDRAM), Dynamic Random Access Memory (DRAM), RAMBUS Dynamic Random Access Memory (RDRAM), flash memory, and/or any other type of random access memory device. In some examples, the memory 133 is implemented by one or more mass storage devices for storing software and data. Examples of such mass storage devices include floppy disk drives, hard drive disks, compact disk drives, and digital versatile disk (DVD) drives. The memory 133 may implement the data store 180. In the illustrated example, the memory 133 stores coded instructions 134. The coded instructions 134 are representative of instructions to perform the processes of FIGS. 6, 7, 8, and/or 9. The coded instructions 134 may be stored in the memory 133, and/or on a removable storage medium such as a CD or DVD, and/or any other physical memory device.

In the illustrated example, the load tester 130 includes the example interface circuit 135. The example interface circuit 135 may be implemented by any type of interface standard, such as an Ethernet interface, a universal serial bus (USB), and/or a PCI express interface. In the illustrated example, one or more input devices are connected to the interface circuit 135. The input device(s) permit a user 125 to enter data and/or commands into the load tester 130. The input device(s) can be implemented by, for example, a keyboard, a mouse, a touchscreen, a track-pad, a trackball, isopoint and/or a voice recognition system.

The example load tester 130 also includes a network communicator 138 such as a modem or network interface card to facilitate exchange of data with external computers via the network 120 (e.g., an Ethernet connection, a digital subscriber line (DSL), a telephone line, coaxial cable, a cellular telephone system, etc.). In some examples the network communicator 138 communicates with the network 120 using one or more wireless technologies (e.g., WiFi, Bluetooth, etc.).

The example user interface script generator 140 of the illustrated example of FIG. 2 is implemented by a processor executing instructions, but it could additionally or alternatively be implemented by an ASIC(s), PLD(s), FPLD(s), and/or other analog and/or digital circuitry. In the illustrated example of FIG. 2, the user interface script generator 140 receives user input from the interface circuit 135 and generates the UI script 145 of FIG. 1. The example user interface script generator 140 monitors user interface events such as, for example, key presses, mouse movements, mouse clicks, window activations, etc. The example user interface script generator 140 creates a UI script 145 based on the user interface events so that they may be played back to simulate user interaction with the application 132. In the illustrated example of FIG. 2, the user interface script generator 140 records interaction of the user 125 via the interface circuit 135 while the user 125 is performing one or more actions to be replicated for load testing purposes. That is, the interactions of the user are designed to perform a particular test against the server 110. However, in some examples, the user interface script generator 140 records user interaction when the user is not performing a particular test against the server 110. Thus, for example, the user interaction recorded by the example user interface script generator 140 might represent any number of varying user activities in association with the server 110.

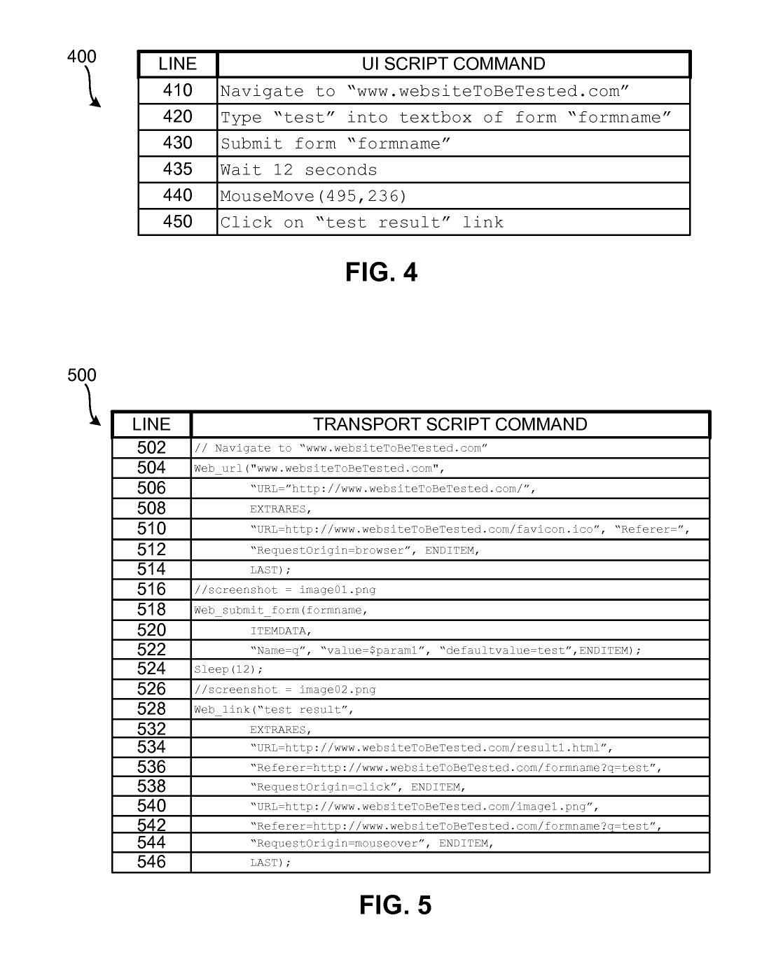

In the illustrated example of FIG. 2, the user interface script 145 is generated by the user interface script generator 140. However, in some examples, the user interface script 145 is generated in a different fashion. For example, the example user interface script 145 may be written by a user. The user interface script 145 is a set of instructions that causes the load tester 130 to perform a test of the server 110. An example user interface script is shown in FIG. 4. In the illustrated example of FIG. 2, the user interface script 145 is stored in the memory 133. However, the user interface script 145 may be stored in any other location. In the illustrated example, the user interface script 145 is a text file that is interpreted by the user interface script executor 150 to implement the test. However, any other type and/or format may additionally or alternatively be used. For example, the user interface script 145 may be an executable.

The example user interface script executor 150 of the illustrated example of FIG. 2 is implemented by a processor executing instructions, but it could additionally or alternatively be implemented by an ASIC(s), PLD(s), FPLD(s), and/or other analog and/or digital circuitry. In the illustrated example of FIG. 2, the user interface script executor 150 executes the user interface script 145 to simulate user interaction. The simulated user interaction caused by the example user interface script executor 150 is user interface level interaction. Example user interface level interactions include mouse movements, mouse clicks, key presses, etc. that are implemented by the user interface script executor 150 to simulate user interaction with the application 132 communicating with the server 110. Because of the simulated interaction with the user interface caused by the example user interface script executor 150, the application 132 communicates with the server 110.

The example transport script generator 160 of the illustrated example of FIG. 2 is implemented by a processor executing instructions, but it could additionally or alternatively be implemented by an ASIC(s), PLD(s), FPLD(s), and/or other analog and/or digital circuitry. While the user interface script executor 150 is simulating user activity, the transport script generator 160 records network communications from the application 132 to the server 110. In the illustrated example of FIG. 2, the network communications include HTTP requests, SQL queries, etc. However, any other past, present, and/or future type of network communications may additionally or alternatively be recorded.

In the illustrated example, the transport script generator 160 generates the transport script 155. The example transport script 155 represents network requests transmitted from the application 132 to the server 110 and/or network responses transmitted from the server 110 to the application 132. When those requests are later re-played by the transport script executor 170, they simulate network communications caused by user interaction. In the illustrated example of FIG. 2, the transport script 155 is stored in the memory 133. However, the transport script 155 may be stored in any other location. In the illustrated example of FIG. 2, the transport script 155 is a text file that is interpreted by the user interface script executor 150 to implement the test. However, any other type and/or format may additionally or alternatively be used such as, for example, an extensible markup language (XML) file, a JavaScript file, etc.

The example transport script modifier 165 of the illustrated example of FIG. 2 is implemented by a processor executing instructions, but it could additionally or alternatively be implemented by an ASIC(s), PLD(s), FPLD(s), and/or other analog and/or digital circuitry. In the illustrated example of FIG. 2, the example transport script modifier 165 integrates user interface information from the UI script 145 into the transport script 155. For example, the transport script modifier 165 identifies transactions (e.g., discrete sets and/or groups of activities performed within the UI script 145) so that those activities can be grouped in the transport script 155. In some examples, the transport script modifier 165 identifies data that may be parameterized. For example, data entered by the user (e.g., a search query, form data, etc.) may be parameterized so that multiple different values may be used during execution of the transport script 155. In some examples, the transport script modifier 165 adds comments regarding the activities performed by the UI script 145 to the transport script 155. Adding comments later enables a developer to more easily debug the transport script 155 in the event of an error. In some examples, the transport script modifier 165 identifies an origin of a request in the transport script 155. For example, the transport script modifier 165 may identify whether a request was caused by user interaction (e.g., by selecting a submit button, by moving a mouse cursor over an object displayed on a webpage, etc.) or whether the request was cause by activities other than user interaction (e.g., loading a website caused other pages and/or objects to be requested, etc.). In some examples, the transport script modifier 165 adds an image (e.g., a screenshot) and/or a reference to the image to the transport script 155. Adding the image enables the developer to identify test scenarios and/or business processes behind the test to more easily debug the transport script in the event of an error.

The example transport script executor 170 of the illustrated example of FIG. 2 is implemented by a processor executing instructions, but it could additionally or alternatively be implemented by an ASIC(s), PLD(s), FPLD(s), and/or other analog and/or digital circuitry. The example transport script executor 170 executes the transport script 155 based on an instruction from a user. However, in some examples, the example transport executor 170 executes the transport script 155 in response to detecting a modification (e.g., an update) to the server. In the illustrated example, the transport script 155 is used to simulate activity of a single user. Accordingly, to simulate multiple users the transport script executor 170 may simultaneously and/or semi-simultaneously execute multiple instances of the transport script 155. For example, to simulate ten thousand users, the transport script 155 may be executed ten thousand times. Further, execution of the transport script 155 may be implemented in any other fashion. For example, the transport script 155 may be consecutively executed (e.g., a second execution of the transport script does not begin until a first execution has completed).

During execution of the transport script 155, the example transport script executor 170 monitors replies to the network requests for failures. A failure may be caused by any number of root causes. For example, the failure might have been caused by a failure of the server 110 (e.g., an error caused by the change made to the server). For example, the failure might have been caused by a misconfiguration between the transport script 155 and the server 110. If, for example, the server 110 was updated, the transport script 155 may no longer be properly formatted for use with the server 110. For example, if a name of a parameter was modified on the server, that parameter name change might not have been replicated to the transport script 155. Accordingly, when a failure is detected, the transport script executor 170 of the illustrated example compares a timestamp of the transport script 155 with a timestamp of the server 110 to determine if the transport script 155 is out of date. If the transport script 155 is out of date, the transport script 155 is automatically regenerated by executing the UI script 145 and monitoring network requests. Automatic regeneration of the transport script 155 ensures that causes of failures encountered during load testing did not originate from the transport script 155.

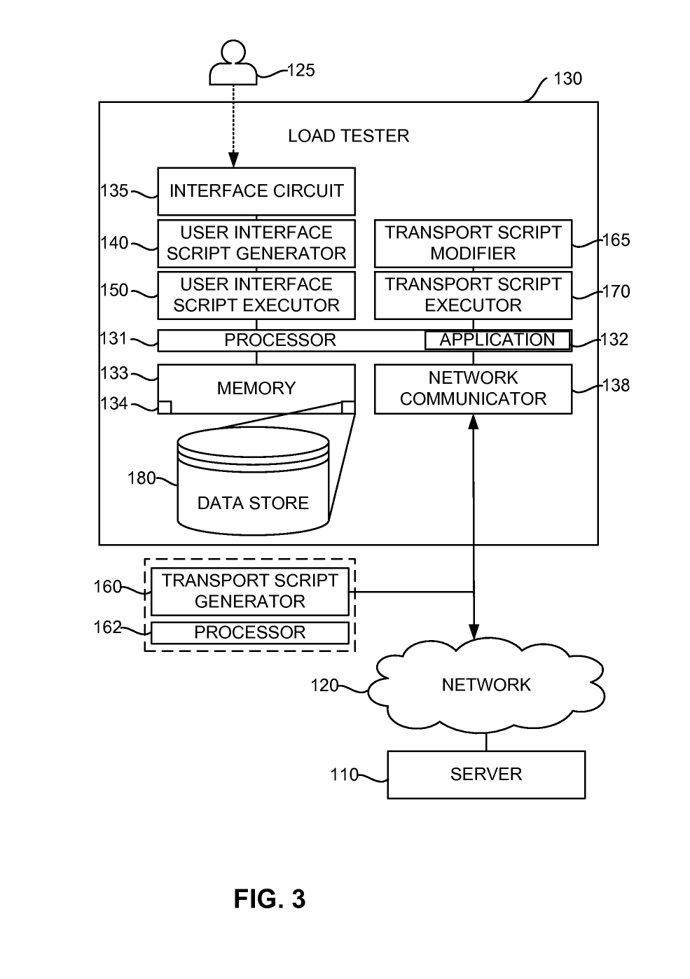

FIG. 3 illustrates another implementation of the example system 200 of FIG. 2. In the example system 300 of FIG. 3, the transport script generator is located apart from the load tester 130. In the illustrated example of FIG. 3, the example transport script modifier 165 is implemented by a processor executing instructions, but it could additionally or alternatively be implemented by an ASIC(s), PLD(s), FPLD(s), and/or other analog and/or digital circuitry. In the illustrated example of FIG. 3, the transport script generator 160 is placed outside of the load tester 130. Thus, rather than locally monitoring network communications between the application 132 and the server 110 (as shown in FIG. 2), the transport script generator 160 of FIG. 3 remotely monitors network communications between the application 132 and the server 110. Accordingly, the example transport script generator 160 of FIG. 3 may be used in combination with a processor 162. The example processor 162 of the illustrated example of FIG. 3 is a silicon-based processor. The processor 132 can be implemented by one or more microprocessors or controllers from any desired processor family or manufacturer.

FIG. 4 illustrates an example user interface script 400 representing an example test case. While the user interface script 400 of the illustrated example represents one test case, many other test cases having any other purpose, configuration, etc. may additionally or alternatively be used. The example user interface script 400 of FIG. 4 is represented as a text file, with each line representing an instruction to be performed to simulate user interaction with the application 132. In the illustrated example of FIG. 4, the user interface script 400 represents the example test case in which a user navigates to a website (e.g., www.websiteToBeTested.com at line 410) associated with (e.g., served by) the server 110 and enters a search term. The example user interface script 400 of FIG. 4 is formatted as a script for use with Hewlett Packard's LoadRunner testing platform. However, the user interface script 400 may be formatted for use with any other system and/or testing platform.

The user interface script 400, when interpreted by the example user interface script executor 150, causes the example user interface script executor 150 to instruct the application 132 to navigate to the website to be tested. (line 410). In the illustrated example of FIG. 4, navigation is implemented by entering a universal resource locator of a website to be tested into a navigation bar of the application 132 and simulating a keystroke of an enter button. However, navigation may be implemented in any other fashion. Once the navigation operation of line 410 is complete, the example user interface script executor 150 simulates keystrokes to input a search term (e.g., “test”) into a textbox of a form on the website. (line 420). In the illustrated example, inputting is implemented by selecting the textbox (e.g., by moving a mouse cursor to a position of the text box and clicking) and simulating user input (e.g., keystrokes) via the interface circuit 135 to enter the search term. While, in the illustrated example, a search term is entered into a textbox, any other type of form operation or other input may additionally or alternatively be performed. For example, a checkbox may be checked, a list box may have an item selected, a scrollbar may be operated, etc.

The user interface script 400, when interpreted by the example user interface script executor 150 of the illustrated example, causes the example user interface script executor 150 to submit the form to the website. (line 430). In the illustrated example of FIG. 4, form submission is implemented by simulating a mouse movement to move the mouse cursor to a position of a submit button associated with the form and simulating a mouse click on the button. However, form submission may be implemented in any other fashion. For example, the user interface script executor 150 may simulate, via the interface circuit 135, an enter key keystroke while an element of the form (e.g., a textbox, etc.) is selected. In the illustrated example, submitting the form (e.g., simulating a mouse click or keystroke to cause the form to be submitted) causes a new webpage to be displayed (e.g., a search results webpage, etc.). The example user interface script executor 150 of FIGS. 2 and/or 3, based on the instruction of the user interface script 400, waits for a time period (e.g., 12 seconds). Waiting for the time period simulates a webpage being displayed to the user for a period of time before the user decides to take an action (e.g., moving the mouse, clicking on a link, etc.).

The UI script 400, when interpreted by the example user interface script executor 150 of the illustrated example, causes the example user interface script executor 150 to simulate (via the example interface circuit 135) a mouse movement to move the mouse cursor to a position within the application 132. (line 440). In the illustrated example, the mouse movement causes an object (e.g., a search result, an image, etc.) to respond to a mouseover event. In the illustrated example, the mouseover event causes a network request to be sent to the server 110. However, mouseover events do not necessarily cause such an action.

In the illustrated example, the example user interface script 400, when interpreted by the example user interface script executor 150, causes the user interface script executor 150 to simulate (via the example interface circuit 135) a mouse click on a link containing the text “test result”. (line 450). In the illustrated example, clicking on the link is implemented by moving the mouse cursor to a position of the link and simulating a mouse click. However, any other way of implementing clicking on a link may additionally or alternatively be used. In the illustrated example, clicking on the link causes a network request to be sent to the server 110.

FIG. 5 illustrates an example transport script 500 that may be used to perform load testing on the example server 110 of FIGS. 2 and/or 3. In the illustrated example of FIG. 5, the transport script 500 is formatted as a JavaScript file. However, any other type and/or format of file may additionally or alternatively be used such as, for example, an extensible markup language (XML) file, etc. Furthermore, any other parameters for forming the JavaScript file may additionally or alternatively be included in the transport scripts 500 such as, for example, comments, tags, functions, etc. Like the UI script 400, the transport script 500 is executed in order. That is, a first line and/or function call (e.g., a multiline function call as shown in lines 504, 506, 508, 510, 512, and 514) is executed before a second line and/or function call. However, the transport script 500 may be executed in any other fashion such as, for example, a non-ordered approach.

The example transport script 500 of FIG. 5 includes instructions which, when interpreted and/or executed, cause the example transport script executor 170 to transmit network communications simulating the example UI script 400 of FIG. 4. Line 502 represents a comment inserted by the transport script modifier 165. The comment indicates that the action performed by the following line represents the application 132 navigating to the website to be tested. Lines 504, 506, 508, 510, 512, and 514 represent an instruction to navigate to the website to be tested. Line 506 specifies a URL of the website to be tested. Lines 510 and 512 represent an extra request that should be transmitted following the request to the website to be tested. In the illustrated example, the extra request simulates the application 132 requesting the icon associated with the website to be tested. However, the request may be directed to any location for any other purpose. In the illustrated example, line 512 is modified by the example transport script modifier 165 to indicate that the request originated from the browser. In some examples, the result is of the request and/or the extra request is validated to ensure that there are no failures. In the illustrated example, results are validated to ensure that an HTTP status code of 200 indicating that the request was successful is returned. However, any other way of validating result(s) may additionally or alternatively be used such as, for example, validating an HTTP status code, validating that a particular text was returned, validating that a response was received in a particular amount of time, etc.

Lines 516 and 526 of the example transport script 500 of FIG. 5 are inserted by the transport script modifier 165 and indicate that screenshot(s) representative of the user interface at the respective stages of the test script are stored as files named “image01.png” and “image02.png”, respectively. In the illustrated example, the indication of the screenshot(s) are inserted as JavaScript comments. However, any other format for identifying the screenshot(s) may additionally or alternatively be used.

Lines 518, 520, and 522 represent an instruction that causes the transport script executor 170 to submit a form contained on the webpage. In the illustrated example of FIG. 5, the form is identified as the form having the name “formname”. (line 518). Line 522 indicates that a parameter is to be submitted with the form. In particular, the parameter is named “q” and has a default value of “test”. However, the transport script modifier 165 inserted a value tag that indicates that the value may be parameterized. When executing the example transport script 500, the example transport script executor 170 may use multiple different values for the parameter “q” other than the default value of “test”.

Line 524 of the example transport script 500 of FIG. 5 causes the example transport script executor 170 to pause (e.g., sleep, wait, etc.) for a pause duration value (e.g., twelve seconds). However, any other pause duration may additionally or alternatively be used. In the illustrated example of FIG. 5, the pause duration value corresponds to the pause duration of line 435 of the example UI script 400. When generating the example transport script 500, the transport script modifier 165 modifies the transport script 500 so that an appropriate wait duration is used. An appropriate wait duration may be determined based on, for example, an inspection of the example UI script 400, a standard wait duration (e.g., one second, five seconds, etc.), etc. If, for example, a different pause duration were used, the transport script 500 might not be an accurate test because it would not replicate activities of a user.

Lines 532, 534, 536, 538, 540, 542, 544, and 546 of the example transport script 500 of FIG. 5 cause the example transport script executor 170 to follow the link labeled “test result”. In particular, lines 534, 536, and 538 instruct the example transport script executor 170 to transmit a first request to the server 110, requesting the file named “result1.html”. In the illustrated example, the transport script modifier 165 inserted a request origin in line 538 based on the UI script 400. The request origin indicates that the origin of the request was a click on a link. Furthermore, lines 540, 542, and 544 instruct the example transport script executor 170 to transmit a second request to the server 110. This second request requests that the file image1.png be provided. (line 540). Furthermore, in the illustrated example, the transport script modifier inserted a request origin in line 544 indicating that the cause of the request was a mouseover event.

While an example manner of implementing the load tester 130 has been illustrated in FIGS. 1, 2, and/or 3, one or more of the elements, processes and/or devices illustrated in FIGS. 1, 2, and/or 3 may be combined, divided, re-arranged, omitted, eliminated and/or implemented in any other way. Further, the example interface circuit 135, the example user interface script generator 140, the example user interface script executor 150, the example transport script generator 160, the example transport script modifier 165, the example transport script executor 170, the example network communicator 138, and/or, more generally, the example load tester 130 of FIGS. 1, 2, and/or 3 may be implemented by hardware, software, firmware and/or any combination of hardware, software and/or firmware. Thus, for example, any of the example interface circuit 135, the example user interface script generator 140, the example user interface script executor 150, the example transport script generator 160, the example transport script modifier 165, the example transport script executor 170, the example network communicator 138, and/or, more generally, the example load tester 130 of FIGS. 1, 2, and/or 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example interface circuit 135, the example user interface script generator 140, the example user interface script executor 150, the example transport script generator 160, the example transport script modifier 165, the example transport script executor 170, and/or the example network communicator 138 are hereby expressly defined to include a tangible computer-readable medium storage device or storage disc such as a memory, DVD, CD, Blu-ray, etc. storing the software and/or firmware. Further still, the example load tester 130 of FIGS. 1, 2, and/or 3 may include one or more elements, processes and/or devices in addition to, or instead of, those illustrated in FIGS. 1, 2, and/or 3, and/or may include more than one of any or all of the illustrated elements, processes and devices.

Flowcharts representative of example machine-readable instructions for implementing the load tester 130 of FIGS. 1, 2, and/or 3 are shown in FIGS. 6, 7, 8, and/or 9. In these examples, the machine-readable instructions comprise a program(s) for execution by a processor such as the processor 131 shown in the example load tester 130 discussed in connection with FIGS. 2 and/or 3. The program(s) may be embodied in software stored on a tangible computer-readable medium such as a CD-ROM, a floppy disk, a hard drive, a digital versatile disk (DVD), a Blu-ray disk, or a memory associated with the processor 131, but the entire program(s) and/or parts thereof could alternatively be executed by a device other than the processor 131 and/or embodied in firmware or dedicated hardware. Further, although the example program(s) are described with reference to the flowcharts illustrated in FIGS. 6, 7, 8, and/or 9, many other methods of implementing the example load tester 130 may alternatively be used. For example, the order of execution of the blocks may be changed, and/or some of the blocks described may be changed, eliminated, or combined.

As mentioned above, the example processes of FIGS. 6, 7, 8, and/or 9 may be implemented using coded instructions (e.g., computer and/or machine readable instructions) stored on a tangible computer-readable storage medium such as a hard disk drive, a flash memory, a read-only memory (ROM), a compact disk (CD), a digital versatile disk (DVD), a cache, a random-access memory (RAM) and/or any other storage device or storage disc in which information is stored for any duration (e.g., for extended time periods, permanently, brief instances, for temporarily buffering, and/or for caching of the information). As used herein, the term tangible computer-readable storage medium is expressly defined to include any type of computer readable storage disc and/or storage device and to exclude propagating signals. As used herein, “tangible computer readable storage medium” and “tangible machine readable storage medium” are used interchangeably. Additionally or alternatively, the example processes of FIGS. 6, 7, 8, and/or 9 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage disc or storage device in which information is stored for any duration (e.g., for extended time periods, permanently, brief instances, for temporarily buffering, and/or for caching of the information). As used herein, the term non-transitory computer-readable medium is expressly defined to include any type of computer-readable disc or storage device and to exclude propagating signals. As used herein, when the phrase “at least” is used as the transition term in a preamble of a claim, it is open-ended in the same manner as the term “comprising” is open ended.

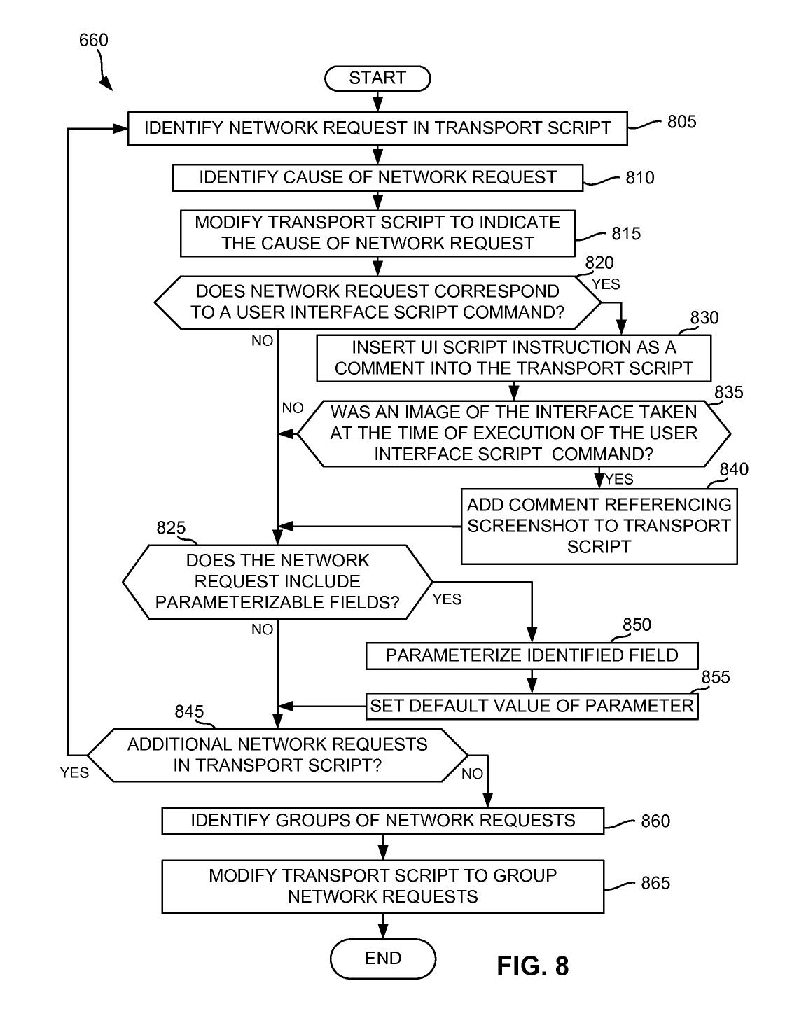

FIG. 6 is a flowchart 600 representative of example machine-readable instructions that may be executed to implement the example load tester 130 of FIGS. 1, 2, and/or 3 to generate a UI script and a transport script. In the illustrated example of FIG. 6, both the UI script and the transport script are generated based on user input. This is useful when, for example, a transport script has not previously been generated, a change has occurred that affects the operation of a previously recorded UI script, a new test plan is being created, etc. The example process 600 begins when the user interface script generator 140 begins recording a UI script. (block 610). At approximately the same time, the transport script generator 160 may begin recording network communications to generate a transport script. (block 620). The user 125 performs actions by controlling the load tester 130 via the interface circuit 135. (block 630). Upon completion of the actions by the user, the user interface script generator 160 stops recording the user input used to generate the UI script. (block 640). The UI script is saved in a memory of the load tester 130 and is later used to re-generate the transport script. The transport script generator 160 stops recording the network communications used to generate the transport script. (block 650). The transport script generator 160 saves the transport script based on the network communications. The transport script modifier 165 then integrates UI information found in the UI script into the transport script. (block 660). Such integrated information is useful for identifying what is being tested by the transport script. For example, a comment may be added to the transport script indicating that the user clicked on a search box. Using the UI script, it is possible to identify, for example, when a page has been loaded, which data was manually entered by the user, when the user interface event occurred (e.g., a button click), etc. Integration of information found in the user interface script to the transport script (block 660) is further described in connection with FIG. 8.

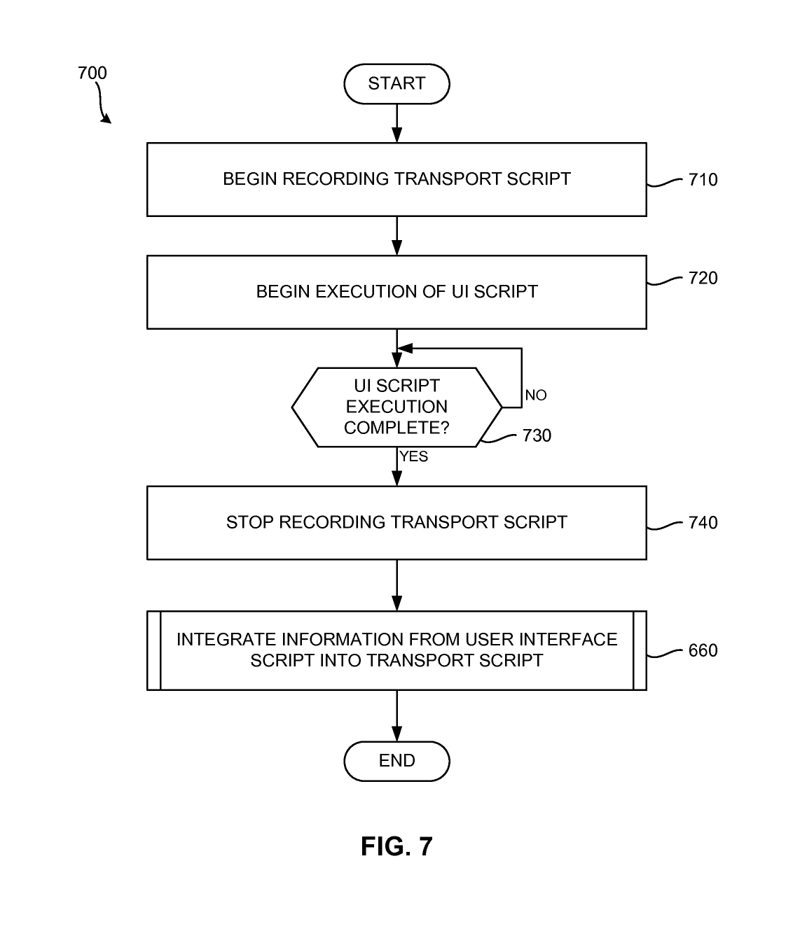

FIG. 7 is a flowchart 700 representative of example machine-readable instructions that may be executed to implement the example load tester 130 of FIGS. 1, 2, and/or 3 to automatically generate the transport script. In the illustrated example of FIG. 7, the transport script is generated based on execution of the UI script. This is useful when, for example, a change has occurred that affects the operation of the transport script, etc. The example process 700 begins when the transport script generator 160 begins recording network communications to generate the transport script. (block 710). The user interface script executor 150 begins execution of the UI script. (block 720). While the user interface script executor 150 is executing the UI script, the transport script generator 160 waits for the execution of the UI script to complete (block 730). If execution of the UI script is not complete, the transport script generator 160 continues to record network communications to generate the transport script (block 730). If execution of the UI script is complete (block 730), the transport script generator 160 stops recording the transport script (block 740), and saves the recorded network communications as the transport script. Using the newly created transport script, the transport script modifier 165 integrates information from the user interface script into the transport script. (block 660).

FIG. 8 is a flowchart 660 representative of example machine-readable instructions that may be executed to implement the example load tester 130 of FIGS. 1, 2, and/or 3 to integrate information from the user interface script into the transport script. In the illustrated example of FIG. 8, the transport script is modified after it has been generated. That is, the transport script is post-processed to integrate information from the UI script.

The example process 660 begins when the example transport script modifier 165 identifies a network request in the transport script. (block 805). In the illustrated example of FIG. 8, the example transport script modifier 165 reads the transport script and sequentially identifies network requests. However, any other approach to identifying network requests in the transport script may additionally or alternatively be used. The example transport script modifier 165 then identifies a cause of the network request. (block 810). In the illustrated example, the cause of the network request is identified by inspecting the UI script to determine what activity occurred at approximately the same time the network request was recorded. For example, the user and/or a simulated user may have clicked on a link causing the network request to be transmitted, the user may have moved the mouse (causing a mouseover event to be triggered) and thereby causing the network request to be transmitted, etc. The example transport script modifier 165 then modifies the transport script to indicate the cause of the network request. (block 815). Examples of the modification to identify an origin of the request can be found in lines 512, 528, and 544 of FIG. 5. In the illustrated example of FIG. 8, the modifications are implemented as parameters associated with URLs to be requested in the transport script. However, any other approach to inserting the origin of the request may additionally or alternatively be used. For example, the origin of the request may be added as a comment in the transport script.

The example transport script modifier 165 determines if the identified network request corresponds to a UI script command. (block 820). In the illustrated example of FIG. 8, whether the identified network request corresponds to the UI script command is identified based on temporal aspects of the network request and the instructions of the UI script. For example, the order of the instructions of the UI script may be analyzed to identify whether the network request corresponds to a UI script command. However, any other way of determining whether the network request corresponds to the UI script command may additionally or alternatively be used. For example, association of the UI script command and the network request may be identified based on the destination of the network request.

If the network request does not correspond to the user interface script command (block 820), the example transport script modifier 165 determines whether the network request includes parameterizable fields. (block 825). If the network request does correspond to the user interface script command (block 820), the example transport script modifier 165 inserts the UI script command as a comment in the transport script. (block 830). Inserting the UI script command enables developers to identify problems within the script. An example of an inserted command from the UI script is shown in line 512 of FIG. 5, which corresponds to the UI script command of line 410 of FIG. 4.

The example transport script modifier 165 determines if an image of the interface was taken at the time of execution of the user interface script command. (block 835). If the image (e.g., a screenshot) was taken, it may assist the developer in debugging the transport script. If the image was taken, the example transport script modifier 165 adds a comment to the transport script referencing a file name of the image. (block 840). Examples of inserted comments referencing screenshots are shown in lines 516 and 526 of FIG. 5.

The example transport script modifier 165 determines whether the network request includes parameterizable fields. (block 825). A parameterizable field represents information that was entered by the user such as, for example, information entered into a textbox, a selection within a list box, a combo box, a checkbox, a radio button, a search query, and/or or any combination of user entered information. While in the illustrated example, parameterizable fields represent information entered by the user, the parameterizable field may represent any other information such as, for example, information displayed in a webpage (e.g., a name of an image, etc.), a previously completed form, a cookie, etc. In the illustrated example, parameterizable fields are identified when the identified network request is caused by a form submission. However, any other way of identifying parameterizable fields may additionally or alternatively be used. For example, a portion of a URL may be parameterized to, for example, enable the transport script to test retrieval of different resources hosted by the server 110.

If the example transport script modifier 165 identifies a parameterizable field (block 825), the example transport script modifier 165 parameterizes the field. (block 850). For example, line 522 of the example transport script 500 of FIG. 5 indicates that the parameter named “q” is parameterized using the variable “$param1”. The variable “$param1” may later be substituted with different values to simulate multiple different inputs to a form. The example transport script modifier 165 sets a default value for the parameterized field. (block 855). In the illustrated example, the default value is determined based on the value that was used in the identified network request. However, any other way of setting a default value may additionally or alternatively be used. In some examples, the example transport script modifier 165 identifies different values that may be used for the parameter. For example, the transport script modifier 165 may identify that the parameter is a listbox and define that a limited number of options are to be used when executing the transport script. For example, if a listbox allows for one of two options to be selected, the example transport script modifier 165 may identify, based on information retrieved from the UI script and/or from the webpage, the options for the listbox that may be used when executing the transport script.

After the fields are parameterized (blocks 850, 855) and/or if no parameterizable fields exist (block 825), the example transport script modifier 165 determines if additional network requests exist in the transport script. (block 845). If there are additional network requests in the transport script, the example transport script modifier 165 identifies and processes the request (block 805). If no additional requests exist in the transport script, the example transport script modifier 165 identifies groups of network requests. (block 860). In the illustrated example, groups of network requests are identified based on their temporal proximity. For example, if a set of network requests occurred in rapid succession (e.g., within five seconds of each other, within ten seconds of each other, etc.) they may be grouped together as they likely relate to a single user interaction (e.g., the user clicked a button and caused multiple requests to be transmitted). If those requests did not occur in rapid succession, they may be related to different activities of the user. However, any other method for grouping requests may additionally or alternatively be used. For example, requests may be grouped based on when the browser loads a new page, when a new instance of the browser is activated, etc. Grouping requests enables a developer to more easily identify what requests are related to each other. Once the groups of requests are identified, the example transport script modifier 165 modifies the transport script to group network requests. (block 865). In the illustrated example, lines 534, 536, 538, 540, 542, and 544 of FIG. 5 represent two grouped requests. In the illustrated example, the two grouped requests of FIG. 5 are grouped as arguments to a single function call (e.g., the function call of line 528 of FIG. 5). However, any other approach to grouping requests may additionally or alternatively be used. For example, a group identifier may be used, comments indicating which group a request is associated with may be used, organizational tags may be used, etc.

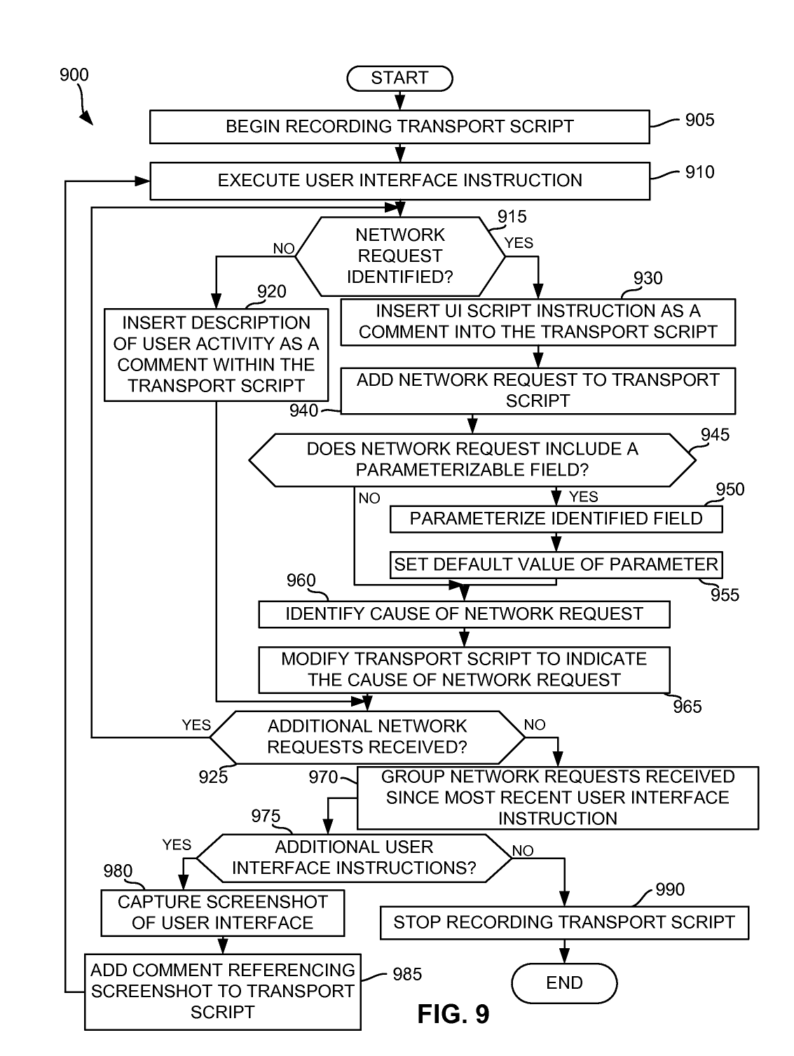

FIG. 9 is a flowchart 900 representative of example machine-readable instructions that may be executed to implement the example load tester 130 of FIGS. 1, 2, and/or 3 to integrate information from the user interface script into the transport script while recording the transport script. In the illustrated example of FIG. 9, the transport script is modified as it is generated. That is, the user interface information is gathered and integrated into the transport script as the transport script is created.

The example process 900 begins when the transport script generator 160 begins recording network communications to generate the transport script. (block 905). The user interface script executor 150 executes a user interface instruction from the UI script. (block 910). While the user interface script executor 150 is executing the instruction from the UI script, the transport script generator 160 monitors the network communicator 138 to identify network requests directed to the server 110. (block 915).

If a network request is not identified, the transport script modifier 165 inserts a description of the user activity as a comment within the transport script. (block 920). In some examples, the description of the user activity comprises the instruction from the user interface script. The transport script executor 170 then waits to determine if any additional network requests are received. (block 925). In the illustrated example, the transport script executor 170 waits for five seconds. However, any other duration may additionally or alternatively be used. Waiting for network requests is beneficial because, in some examples, network requests might not occur immediately after an action is performed against the user interface.

If a network request is identified (block 915), the transport script modifier 165 inserts the executed UI script instruction as a comment into the transport script. (block 930). However, in some examples, the example transport script modifier 165 inserts other information associated with the UI script instruction such as, for example a reference (e.g., a hyperlink, a name, etc.) to an image representing the user interface at approximately the time the user interface instruction was executed.

The example transport script modifier 165 adds the network request to the transport script. (block 940). The example transport script modifier 165 determines whether the network request includes a parameterizable field. (block 945). A parameterizable field represents information entered by the user such as, for example, information entered into a textbox, a selection within a list box, a combo box, a checkbox, a radio button, a search query, and/or or any combination of user entered information. While in the illustrated example, parameterizable fields represent information entered by the user, the parameterizable field may represent any other information such as, for example, information displayed in a webpage (e.g., a name of an image, etc.), a previously completed form, a cookie, etc. In the illustrated example, parameterizable fields are identified when the identified network request is caused by a form submission. However, any other way of identifying parameterizable fields may additionally or alternatively be used. For example, a portion of a URL may be parameterized to, for example, enable the transport script to test retrieval of different resources hosted by the server 110.

If the example transport script modifier 165 identifies a parameterizable field, the example transport script modifier 165 parameterizes the field. (block 950). For example, line 522 of the example transport script 500 of FIG. 5 indicates that the parameter named “q” is parameterized using the variable “$param1”. The variable “$param1” may later be substituted with different values to simulate multiple different inputs to a form. The example transport script modifier 165 sets a default value for the parameterized field. (block 955). In the illustrated example, the default value is determined based on the value that was used in the identified network request. However, any other way of setting a default value may additionally or alternatively be used. In some examples, the example transport script modifier 165 identifies different values that may be used for the parameter. For example, the example transport script modifier 165 may identify that the parameter is a listbox and define that a limited number of options are to be used when executing the transport script. For example, if a listbox allows for one of two options to be selected, the example transport script modifier 165 may identify, based on information retrieved from the UI script and/or from the webpage, the options for the listbox that may be used when executing the transport script.

The example transport script modifier 165 identifies a cause of the network request. (block 960). In the illustrated example, the cause of the network request is identified by inspecting the UI script to determine what activity occurred at approximately the same time the network request was recorded. For example, the user and/or a simulated user may have clicked on a link that causing the network request to be transmitted, the user may have moved the mouse (causing a mouseover event to be triggered) and thereby causing the network request to be transmitted, etc. The example transport script modifier 165 then modifies the transport script to indicate the cause of the network request. (block 965). Examples of the modification to identify an origin of the request can be found in lines 512, 528, and 544 of FIG. 5. In the illustrated example, the modifications are implemented as parameters associated with URLs to be requested in the transport script. However, any other approach to inserting the origin of the request may additionally or alternatively be used. For example, the origin of the request may be added as a comment in the transport script.

The transport script generator 160 then waits to determine if any additional network requests are received. (block 925). As described above, the transport script executor 170 of the illustrated example waits for five seconds. However, any other duration may additionally or alternatively be used. Waiting for network requests enables identification of network requests that do not occur immediately following execution of an instruction of the UI script. If additional network requests are received, the example transport script generator 160 processes the additional network requests (block 915).

If no additional network requests are received, the example transport script modifier 165 groups network requests received since the execution of the most recent (e.g., the latest) instruction from the UI script. (block 970). Because network requests to be grouped were received since execution of the last instruction from the most recent instruction from the UI script, it is assumed that those network requests were made in association with the most recent instruction from the UI script.

The UI script executor 150 determines whether there are any additional user interface instructions to be executed. (block 975). In the illustrated example, the UI script executor 150 determines whether there are any additional user interface instructions to be executed by identifying whether execution of the UI script is complete. If there are additional user interface instructions to execute, the example UI script executor 150 captures a screenshot of the user interface. (block 980). The screenshot is saved to the memory 133 and/or, more particularly, to the data store 180. In the illustrated example, the screenshot is captured using a portable networks graphics (png) format. However, any other image format may additionally or alternatively be used. For example, the screenshot may be captured using a bitmap (bmp) format, a tagged image file format (TIFF), etc. Furthermore, instead of capturing a screenshot, the example UI script executor 150 may capture one or more video(s) of the execution of the UI script. The transport script modifier 165 then adds a comment to the transport script referencing the screenshot. (block 985). Examples of inserted comments referencing screenshots are shown in lines 516 and 526 of FIG. 5. However, any other type of reference may additionally or alternatively be used. The UI script executor 150 then proceeds to execute the next user interface instruction. (block 910). If no additional user interface instructions exist (block 975), the transport script generator 160 stops recording the transport script. (block 990). The process 900 then terminates.

Although certain example methods, apparatus, and articles of manufacture have been described herein, the scope of coverage of this patent is not limited thereto. On the contrary, this patent covers all methods, apparatus, and articles of manufacture fairly falling within the scope of the claims of this patent.

What is claimed is:

1. An apparatus comprising:
a processor;
a memory comprising machine-readable instructions which, when executed by the processor, cause the processor to perform operations comprising:
monitoring network requests in response to execution of a user interface script;
modifying a transport script based on the network requests by:
determining whether a first one of the network requests corresponds to a user interface script command of the user interface script; and
when the first network request corresponds to the user interface script command, inserting the user interface script command as a comment to the transport script.

2. The apparatus as described in claim 1, wherein the instructions further cause the processor to perform the operations comprising, in response to determining the first network request includes a parameterizable field, parameterizing the parameterizable field in the transport script.

3. The apparatus as described in claim 2, wherein the instructions further cause the processor to insert a default value for the parameterized field in the transport script.

4. The apparatus as described in claim 1, wherein the network requests are hypertext transfer protocol requests to be sent from an application stored on the memory to the server.

5. A method of creating a transport script, the method comprising:
executing a user interface instruction from a user interface script;
determining if a network request is identified in response to execution of the user interface instruction;
adding the network request to a transport script if the network request is identified in response to execution of the user interface instruction; and
adding the user interface instruction as a comment to the transport script if the network request is identified in response to execution of the user interface instruction.

6. The method as described in claim 5, further comprising parameterizing a parameterizable field of the network request prior to adding the network request to the transport script.

7. The method as described in claim 7, further comprising adding a default value of the parameterizable field to the transport script.

8. The method as described in claim 7, wherein the default value is a value of the parameterizable field identified in the network request.

9. The method as described in claim 5, further comprising:
identifying a cause of the network request; and
modifying the transport script to indicate the cause of the network request.

10. The method as described in claim 5, wherein the user interface instruction is a first user interface instruction and the network request is a first network request, and further comprising:
identifying a second network request prior to execution of a second user interface instruction; and
grouping the first network request and the second network request based on an association of the first network request and the second network request with the first user interface instruction.

11. The method as described in claim 5, further comprising:
capturing a screenshot representative of a user interface automated by the user interface script; and
adding a comment referencing the screenshot to the transport script.

12. A tangible machine-readable storage medium comprising instructions which, when executed, cause a machine to at least:
determine if a network request is identified in response to execution of a user interface instruction; and
add the network request to a transport script if the network request is identified in response to execution of the user interface instruction;
add a user interface instruction as a comment to the transport script if the network request is identified in response to execution of the user interface instruction.

13. The tangible machine-readable storage medium described in claim 12, further comprising instructions which, when executed, cause the machine to parameterize a parameterizable field of the network request prior to adding the network request to the transport script.

14. The tangible machine-readable storage medium described in claim 12, wherein the user interface instruction is a first user interface instruction and the network request is a first network request, and further comprising instructions which, when executed, cause the machine to at least:
identify a second network request prior to execution of a second user interface instruction; and
group the first network request and the second network request based on an association of the first network request and the second network request with the first user interface instruction.

15. The tangible machine-readable storage medium described in claim 12, further comprising instructions which, when executed, cause the machine to at least:
capture a screenshot representative of a user interface automated by the user interface script; and
add a comment referencing the screenshot to the transport script.
